(19) United States
(12) Patent Application Publication
(10) Pub. No.: US 2005/0230353 A1
(43) Pub. Date: Oct. 20, 2005

(54) Method and array for processing carrier materials by means of heavy ion radiation and subsequent etching

(76) Inventor: Manfred Danziger, Quedlinburg (DE)

Correspondence Address: Law Offices of Karl Hormann, P O Box 381516, Cambridge, MA, 02238-1516, US

(21) Appl. No.: 10/520,366

(22) PCT Filed: Jul. 23, 2003
(86) PCT No.: PCT/DE03/02533

§ 371 Date: Jan. 6, 2005

(30) Foreign Application Priority Data
Jul. 24, 2002 (DE) 102 34 614.3

(51) Int. Cl. B44C 1/22

(52) U.S. Cl. 216/87; 156/345.11

(57) ABSTRACT

A method and a system for processing carrier materials by means of heavy ion irradiation and subsequent etching, wherein the irradiation with heavy ions is carried out in such a way that a beam (1) of a high-energy heavy ion radiation (1.1) impinges on the surface (2) of a carrier material under at least two different angles. The fluence, energy and impinging direction of the heavy ion rays (1.1) are selected in such a way that there will result a maximum number of intersecting or coinciding latent ion traces (3) and common intersections of the recesses (4) resulting from a chemical etching process following heavy ion irradiation are obtained.

The invention relates to a method and a system for processing dielectric carrier material by heavy ion irradiation and subsequent etching which make it possible to emboss a surface depth relief into the carrier material which forms the basis for passive or active layers connectively applied to the carrier material.

It is known that when irradiating dielectric materials (polymers, glasses, etc.) with high-energy heavy ions so-called “latent traces” of a diameter in the nanometer range (10 to several 10 nm) are created in these materials along the trajectories of the ions moving through the material as a result of energy dissipation by radiation interactions and subsequent secondary reactions. The length of these traces is a function of the influx energy of the ions. Within these latent traces, the material is modified by the radiation and possesses physical and chemical properties different from those of the surrounding dielectric material. It is thus possible by suitable subsequent processes, usually be chemical etching, to remove the radiation-modified material along the latent traces and in this manner to form so-called “recesses” such as, for instance, etch pits or channel-like structures of various configurations. Etch pits result if the bombarding energy is insufficient to permeate the irradiated material; however, if the energy is sufficient, so-called “micro-channels” are formed. In addition to such irradiation parameters as type of ion, influx energy, irradiation angle, target material (composition and structure of the irradiated medium), the shape of the recesses formed is dependent upon the etching rate of the unchanged material (material etching rate v_{B}) and of the modified material in the latent ion trace (trace etching rate v_{S}). These two parameters may be varied by the selected etching agent, its concentration and temperature. Since aside from the irradiation conditions the material etching rate v_{B} may additionally be varied by sensitizing (UV-irradiation prior to etching, effect of oxygen, effects of solvents), purpose-related processing of the material may be carried out by the selection of conditions relating to irradiation, etching and, optionally, sensitization.

Aside from usage in dosimetry (where the number of etching pits formed is considered to be a measure of the applied irradiation dose) further technically relevant applications are known based on the described methods of irradiation and subsequent etching.

In the fabrication of ion trace membranes for filtering purposes, polymeric foils made, for instance, of polyester or polyimide are irradiated by heavy ions such that the ions impinge vertically upon the surface of the foil. The bombardment energy selected must ensure complete permeation of the foil, and the energy transfer per length of path (dE/dx) should be as constant as possible during the entire ion trajectory. The follow-up etching process is optimized such that the resultant recesses are shaped in the manner of cylindrical channels of defined diameter. As a result of the exact cylindrical shape the channels of the filtering membrane do not become plugged up when used and after back flushing of the filtered residue the initial filtering rate is achieved again. The setting of a defined size of pores makes it possible to fabricate ion trace membranes for different fields of application (as bacteria filters, for clarifying processes, etc.). European Patent specification No. EP 0,583,605 A1 discloses a method of fabricating such micro-pores by etching particle traces.

The publications DE 2,916,006 A1 and EP 0,583,605 A1 disclose the combination of heavy ion irradiation, subsequent etching and subsequent coating of the support surface. They disclose the following method steps for fabricating adherent metal layers on dielectric media without bonding intermediate layers: Irradiation of different dielectric media by heavy ions (mass>10 and bombardment energy>0.1 MeV/amu), especially at an oblique impinging direction of the radiation up to achieving a non-defined fluence. The subsequent etching is carried out until the pits have attained a desired size and thus results in a defined surface roughening. What may conveniently be labeled a “zipper-effect” of etched pits extending obliquely into the surface results in increased connection strength of a metal layer subsequently applied by conventional processes. Extensive tests by the inventor have shown that though it is possible under laboratory conditions to fabricate composites of a carrier foil and metal layer of desired connection strength (≧0.8 N/mm in accordance with DIN), yet they do not stand up to practical demands especially in respect of immunity from the effects of humidity. The reason for this is that under the effect of humidity on the carrier foil the “anchoring” between carrier foil and metal layer is dissolved (humidity-induced glide effects; “barrel soap effect”), so that the stable connection of the two components as required for practical purposes is possible only in a dry state.

It is also known to fabricate ion trace membranes for a directional current passage. The irradiation of the polymer foils is carried out in the same manner as in the production of filter membranes. However, the subsequent etching process, which establishes the formation of channels through the foil, is in this case optimized such that channels of equal shape and size are generated, the cylindrical configuration being the desirable one. Further process step result in only the formed channels being filled with metal, the remainder of the surface not being metallized. In this manner, a membrane is created which is electrically conductive only normal to its surface: These approaches are described in the publications DE 196 50 881 A1 and DE 33 37 049 A1.

Furthermore, a method of processing carrier foils by irradiation with heavy ions is known from DE 100 58 822 A1. This invention aims at improving the connection strength the carrier foils and a functional layer to be applied.

During its irradiation, the material to be irradiated is guided over a roller system including a deflection roller, a feed roller, a take-up roller and two fixing rollers. The deflection roller may be vertically adjusted on a rail parallel to the direction of propagation of the ion beam. By means of the vertically adjustable deflection roller and the fixing rollers the carrier foils may be aligned at two different angles relative to the direction propagation of the ion beams such that the irradiation with the heavy ions generates a surface depth relief of latent ion traces. Material components of the functional layer to be applied extend into the ion traces etched into pits or recesses and thus anchor the functional layer in the carrier foil.

The process there described constitutes an initial imperfect beginnings of an irradiation of carrier foils in which the heavy ions can impinge at different angles of bombardment.

U.S. Pat. No. 4,416,724 discloses a process of enlarging the surface of a non-conductor by irradiation with heavy ions with the generated latent ion traces being widened by an etching process following the irradiation.

Irradiation takes place in a vacuum, the beam direction of the collimated heavy ion beam being partially affected by a rotating grid and by a magnetic deflection device. In this manner, the surface of the non-conductor may be enlarged up to 1,000 times the value of its original surface. The radiation energy, the radiation density and the radiation medium are mentioned as parameters for generating a suitable surface porosity.

In respect of the scope of their applicability, the method steps described in connection with the mentioned solutions are closely limited to the stated goals of their processes. It is not possible with the elements of the prior art to generate a suitable structure (surface depth relief) representing a reliable and stable basis for the application and sufficiently strong and lasting connection strength of useful layers. The known means can only provide for an adhesion of such layers on the support which are not subject to any special stresses. If, however, the adhering layers are subjected to mechanical or humid conditions for instance, the connection between support and layer will not be a long-wearing one. For this reason, bonding agents are generally used which improve the connection strength of the applied layers but which may nevertheless fail under humid conditions for instance. It is also possible to subject the carrier foils to mechanical or thermal surface treatments but these would significantly increase the production complexity.

It is, therefore, an object of the invention to develop an approach which allows processing of carrier foils such that passive or active layers may be applied in an extremely adhering manner. The technology to be developed is to replace the use of bonding agents and any mechanical or thermal surface treatment during or prior to coating of the carrier foil.

In the accomplishment of this object, the invention provides for a method and an arrangement as set forth by the principal characteristics of claims 1 and 9. Improvements of the invention are set forth in the respective appurtenant sub-claims.

In the method according to the invention irradiation and etching are always carried out such that recesses (pores and the like) are formed which do not permeate through a carrier foil. This allows formation of a surface structure which makes a subsequent adhering coating possible.

In accordance with the invention the heavy ions must penetrate into the carrier material from at least two different impinging angles. The range of the ions, i.e. their depth of penetration, is changed in accordance with requirements by varying the bombardment energy. The different directions of irradiation and sufficiently long etching result in varying surface depth reliefs. “Surface depth relief” connotes that structuring from the surface up to a predetermined depth of the material results to a certain extent in blurring of the differences between surface and volume in the structured area. The generated relief is reminiscent of a fractal structure characterized by the fractal dimension D of 2<D<3, with D increasing from the surface and attains a value of 3 upon reaching the volume no longer affected by the structuring.

The formation of undercut recesses (e.g. truncated shapes and cavities) is particularly advantageous in such fissured structures. To the extent they can be filled by the second component of the composite, the formed undercuttings, generated by the above-described fractal structure, constitute the basis of a lasting strong adhesion of the cover layer.

The intended connection strength is not the result of mechanical action only, but also of physical forces occurring on the surface such as, for instance, polarization, dipol-dipol-effects, van der Waal forces, etc. While the latter are strongly reduced by the effect of humidity, the mechanically conditioned bonding action remains unchanged.

The lasting connection strength in the sense described above can be further improved by generating common intersections of recesses. “Common intersection” connotes the meeting or crossing of two recesses.

In accordance with the invention, a precondition of this method in this case as well, is irradiation of the carrier material from at least two impinging angles.

The fluence and direction of bombardment of the heavy ions are selected so as to result in generating a maximum number of intersecting or meeting units of volume in the interior of which the generated ion traces will be present. The recesses which are formed by one of the etching processes following the irradiation are provided with so-called common intersections.

In order to attain a maximum of lasting connection strength by common intersections the irradiation parameters need be specially dimensioned. The following five parameters must be taken into consideration:
a) applied ion fluence;
b) impinging angle of the heavy ions on the carrier surface;
c) angle of the different directions of bombardment of the ions directed against each other;
d) range of radiation in the solid material; and
e) influx energy or energy dissipation per unit length along the trajectories of the high-energy heavy ions penetrating into the solid material.

Especially high values of connection strength are obtained by selecting the parameters of irradiation and etching such that following the etching process a surface depth relief has been formed which in the area near the surface possesses the fractal surface structure which has already be described and recesses with frequently occurring common intersections in areas removed from the surface.

For industrial applications of the ion trace technology the required high-energy heavy ions are generated by accelerators. As a rule accelerators are designed to provide high-energy heavy ions of discreet energy values. In a normal case it is thus necessary to use an additional device which is positioned in the beam guide channel of the irradiation apparatus, i.e. ahead of the carrier material to be irradiated. By means of this device it is possible to adjust the beam to a predetermined energy value which is representative of the influx value of the ion energy for the solid material to be irradiated (e.g. a polymeric foil). The device will hereafter be called deceleration module and may consist, for instance, of thin metal foils. In accordance with the invention the deceleration module is arranged in the direction of the propagation of the heavy ion beams ahead of the roller system and, therefore, in front of the carrier material to be irradiated. The adjustment of the influx energy which has to be less than the energy level of the ions after leaving the accelerator takes place by the high-energy heavy ions losing energy during their penetration through thin metal foils. Hence, a discrete predetermined influx energy corresponding to the energy level desired for the solid body to be irradiated, can be generated by selection of the thickness of the metal foils.

As regards the irradiation technology, there are two possible variants for the realization of the method referred to supra:

On the one hand, the influx angle relative to the surfaces and radiation directed against each other is kept constant by appropriate collimation of the impinging radiation from at least two directions so that only fluence and range of the heavy ion radiation need be tuned relative to each other in order to generate a maximum of intersection within a defined area of the carrier material.

On the other hand, no collimation of the heavy ion radiation impinging from at least two directions will be provided so that as a result of the thus possible variation of the impinging and intersecting angles the formation and distribution of intersections in the carrier material take place substantially stochastically. In that case, all parameters must be included in the optimization which would require a solution by computer simulation of the process in order to determine the conditions for a maximum value regarding intersections.

The etching conditions of the irradiated material have to be selected to form optimally shaped recesses. In this connection, it is desirable to aim at an aspect ratio A, i.e. the ratio of the length of pores to diameter of the pores, of ≧3.

The inventive combination of irradiation and etching conditions makes it possible, by way of the method of operation not only to produce undercuttings but also, because of the connected pores present at the intersections, so-called “tie-ins” which guarantee a lasting strong connection strength of the cover layer of the composite anchored thereto.

The present invention makes possible the fabrication of composites of a carrier material and cover layers without any bonding agent of any kind. The composites are characterized by lasting high values of connection strength, especially under conditions in which they contact water or aqueous solutions or highly humid atmospheres.

In accordance with the invention the connection strength of applied layers can be further improved by overetching.

A preferred embodiment for an irradiation device of the novel method is characterized by an ion trace foil being transported as a carrier foil over a guide system and being arranged with an adjustable angle of inclination ±α₁/±α₂ relative to the impinging ion beams with the edges of the foil sheet guided at this angle of inclination extending symmetrically or asymmetrically relative to the longitudinal direction of the ion beams.

The symmetrically or asymmetrically constructed guide system may be structured as a roller system with an upstream deceleration module for adjusting the ion influx energy and may consist of a take-up roller for the irradiated carrier foil at the end of the processing path, two fixing rollers each moved inwardly towards the center and disposed above the plane of feed and take-up rollers and deflection rollers preferably positioned in the middle between the fixing rollers. For adjusting the influx angle +α₁/−α₂ of the ion beams onto the carrier foil the deflection roller is arranged for vertical adjustment along an area of the axis of symmetry or parallel to the axis of symmetry of the roller system. For different influx angles +α₁/−α₂ the deceleration module may be used such that for each particular influx angle (e.g. for +α₁ or for −α₂) a corresponding value of influx energy of the penetrating ions may be set by constructing the module of partial components of deceleration foils of different thicknesses. In a particular embodiment the deceleration module, over its longitudinal extent, is provided with foils of different thickness in order to ensure a desired influx value of the ions penetrating into the carrier material (2) for each influx angle +α₁ or −α₂.

The deflection roller is vertically adjusted, for instance, by its guidance on a rail.

For a more detailed explanation of the invention, reference may be had to the patent claims.

Details, characteristics and advantages of the invention will become apparent from the ensuing specification of embodiments. In the appurtenant drawings:

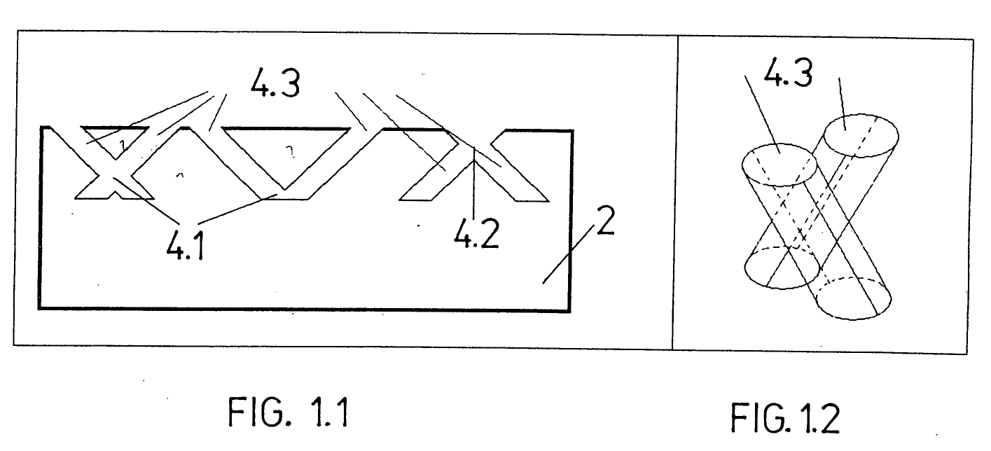

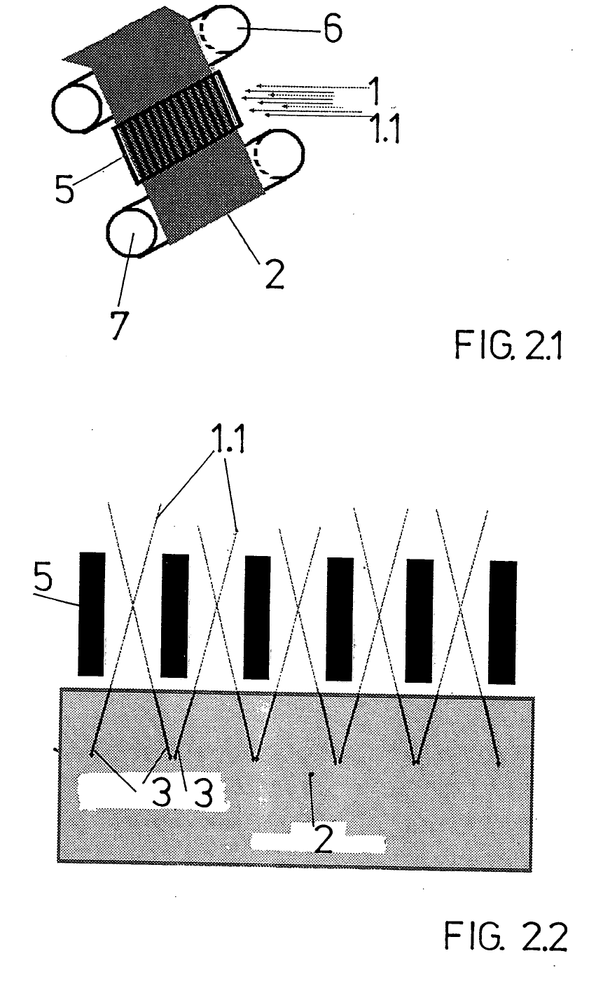

FIG. 1 is a schematic presentation of possible common intersections of recesses in ion trace foils;

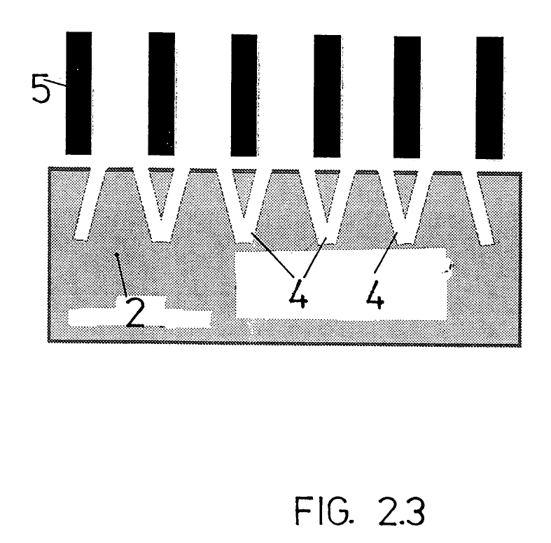

FIG. 2 depicts a variant of an embodiment of the method in accordance with the invention with collimation of the high-energy heavy ions;

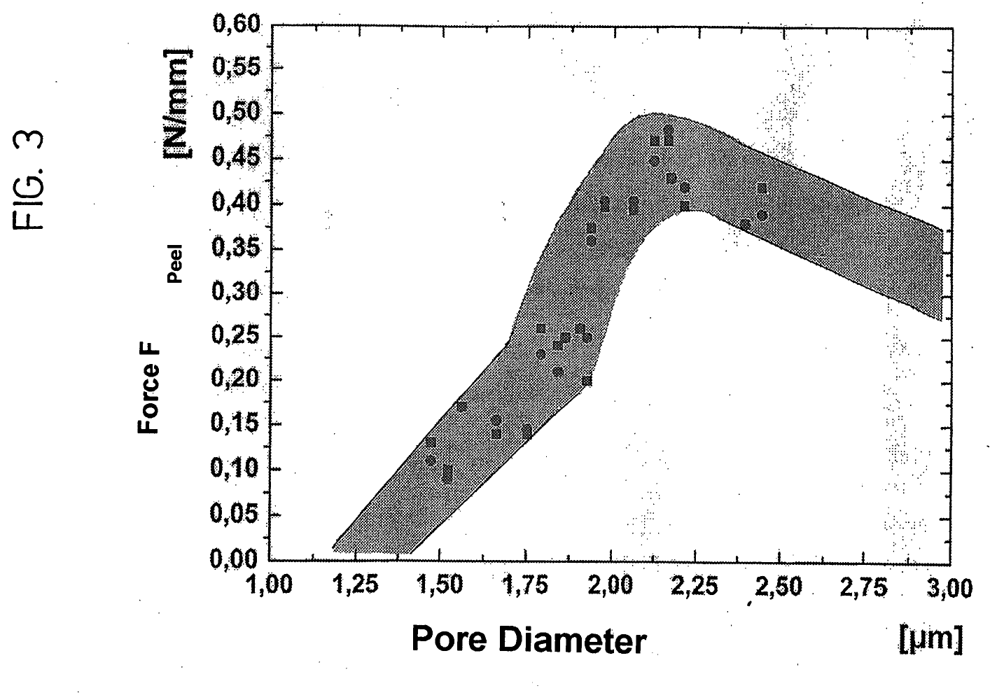

FIG. 3 is a representation of the course of the connection strength of such composite components as an ion trace foil and copper as a function of pore diameter of the ion trace foil;

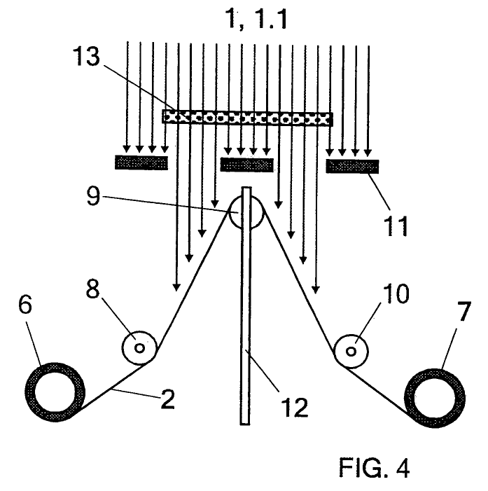

FIG. 4 depicts the schematic structure of an arrangement with a deceleration module for practicing the irradiation process of a foil;

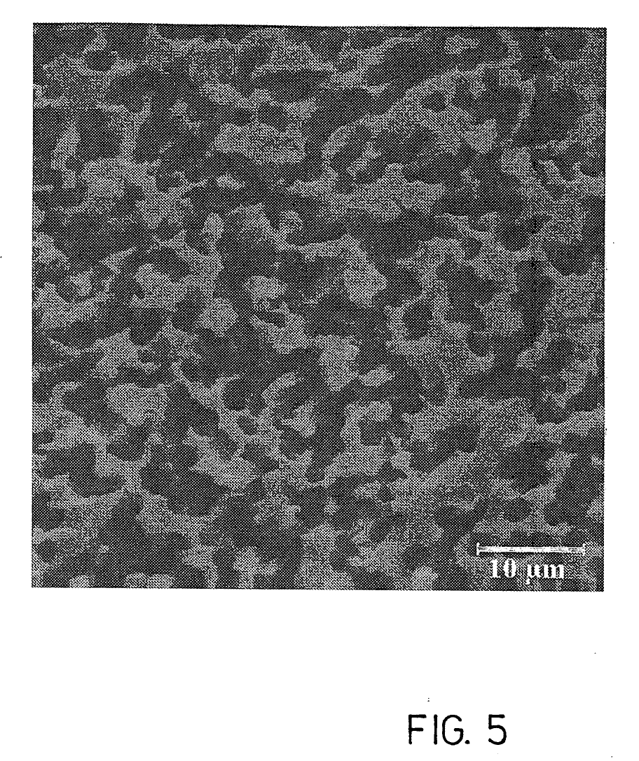

FIG. 5 is a plan view of an electron-microscope image of a typical profile of a strongly fissured surface with a strong depth relief in a polyester ion trace foil.

FIG. 1 depicts the creation of common intersections of recesses 4 in ion trace foils 2. FIG. 1.1 is a sectional view through a carrier foil 2 with two coinciding pairs 4.1 which contribute significantly to the connection strength and one coinciding pair which contributes little to connection strength. FIG. 1.2 additionally shows a spatial representation of an intersection 4.1 with recesses (pores) 4.3.

FIG. 2 is a schematic view of an advantageous variant for practicing the method in accordance with the invention with collimation of the high-energy heavy ion beams 1 for producing as large a number of common intersections 4 of recesses as possible in ion trace foils 2. A common intersection 4 connotes the coinciding or crossing of two recesses.

FIG. 2.1 schematically depicts an irradiation mask 5. The foil 2 unwound from and wound on rolls 6 and 7 is passed twice under the mask 5; the ions 1.2 are beamed during each passing of the foil at a bombardment angle ±α.

FIG. 2.2 schematically depicts, in relation to an intersection, the ion trajectories 1.1 permeating the mask 5 and penetrating into the solid material 2. As a result of this method step latent ion traces 3 are generated prior to the subsequent etching process. The subject matter of FIG. 2.3 is the schematic presentation of the creation of intersections in a sectional plane.

What is shown is the common intersection 4 of recesses (pores) after the etching process.

FIG. 3 depicts the graphic evaluation of an connection strength test of composites consisting of ion trace foils 2 (polyimide) and copper as a function of pore diameter of the ion trace foil. The pulling-off test was performed immediately after removal of the samples from an aqueous solution.

In order to explain the effect of common intersections on the connection strength of a composite consisting of two components the relative porosity, i.e. the ratio of the etched to the non-etched surface, may be taken as a measure of the effectiveness of the method of forming the surface-depth-relief. The following is true for a constant ion fluence: the greater the porosity the greater the number of common intersections and, hence, the connection strength. Since at an increasing porosity the diameter of the recesses also increases, the probability of the formation of common intersections increases as well. However, at a very great porosity, generated by strong overetching, one may observe a reduction of connection strength since overetching results in the destruction of recesses. At the same time, an increase in pore diameter leads to a reduced aspect ratio and to a reduction in the proportion of the solid material in the volume segment of the carrier foil material. That, too, causes a deterioration in the value of the connection strength. On the basis of these counter-acting effects, the resultant maximum in the connection strength curve depending upon the porosity is as shown in FIG. 3.

FIG. 4 schematically depicts an arrangement with a deceleration module for executing the operation of irradiating a polyester foil to be used as the carrier foil of a flexible circuit board.

In a first example of application, an ion trace foil 2 is processed as a carrier foil of a semi-rigid layer of copper for use as a starter material for flexible circuit boards.

As shown in FIG. 4, a foil 2 of a thickness of 50 μm consisting of polyethylene terephthalate (PETP, a so-called polyester) is subjected to irradiation by an ⁸⁴Kr⁺ (krypton)-ion beam 1. For this purpose, the starter material provided in a roll (width 50 cm) is moved through the bundle of ion rays 1 over a roller system consisting of five rollers. Upstream of the roller system 6, 7, 8, 9, 10, 12 there is provided, in the direction of propagation of the heavy ion beam 1.1, a deceleration module 13, which is arranged orthogonally relative to the direction of propagation of the ion beam 1.1, ahead of the roller system 6, 7, 8, 9, 10, 12, and which is permeated by the bundle of rays 1 and which determines the influx energy of the ions into the foil material. The roller system which in this case is structured symmetrically, consists of a feed roller 6 for the polyester foil 2 and a take-up roller 7 for the polyester foil 2 followings it irradiation. Between these rollers, there are provided a first fixing roller 8, a deflection roller 9 as well as a second fixing roller 10. The bundle of ion rays 1 sweeps the area between the two fixing rollers 8 and 10, an aperture or diaphragm 11 being provided for selectively blocking any partial section of the bundle of ion rays 1. The deflection roller 9 is mounted on a rail 12 for sliding movement parallel to the direction of the bundle of ion rays 1 and thus allows to vary the influx angle α of the ions between −70° and +700 relative to the a line extending normal to the surface.

In the present embodiment, the influx angle is set at 45°. The partial area in which the deflection roller 9 is positioned is blocked out of the bundle of ion rays 1. Thus, there are only two effective partial beam portions with which the influx angles −45° and +45° may be associated. Within the mentioned angles they generate two families of latent ion traces 3. The total irradiation density (fluence) amounts to 5·10⁷ cm⁻².

The influx energy of the ions is 1.2 MeV/am which leads to an average range of 20 μm.

The irradiated foils 2 are then subjected to etching with a 3 molar NaOH solution for 10 to 30 minutes at a temperature of 80° C. The result of the etching is opening of the latent ion traces 3 to cylindrical closed-bottom recesses of 2 μm diameter and a depth of about 18 to 19 μm. This length is somewhat less than the depth of penetration of the ions since at the end of the ion trace the transfer of energy to the polyester foil 11 becomes so small that the trace cannot be etched. The length of the section which cannot be etched amounts to about 5 to 10 of the entire length of the ion trace.

To fabricate the functional layer, a starter layer of a thickness of 0.2 to 0.4 μm and consisting of copper is applied by sputtering (vacuum deposition). The copper layer proper of a thickness of 5 to 140 μm is afterwards galvanically precipitated. The copper-coated polyester foil thus fabricated is characterized by a high connection strength of the cover layer (>2 N/m) established by it mechanical anchoring in the pores of the base material. It is very suitable for use as a flexible circuit board for high mechanical alternating stresses.

In a second embodiment, an ion trace foil is processed with a high specific surface for supporting an aluminum coating.

A polyester foil 2 consisting of polyethylene terephthalate (PETP) of a thickness of 23 μm is subject to irradiation by ⁴⁰Ar⁺-ions 1. For this purpose, the rolled starter material (width 50 cm) is fed over the roller system 7-10 described in connection with the first embodiment. In this case, the influx angle α is set at ±30°, i.e. irradiation is successively carried out within angles +30° and −30° relative to a line extending normal to the surface of the foil 2. The radiation density is 5·10⁷ cm⁻². The influx energy of the ions is set at 0.11 MeV/amu by the deceleration module. This results in latent ion traces the effective (etchable) length of which is about 7 μm.

The surface of the irradiated foil 2 is then subjected to etching for 6 to 8 minutes at a temperature of 90° C. in a 5-molar NaOH solution causing the latent ion traces 3 to be opened to frusto-conical cavities or closed-bottom recesses of a depth of about 7 μm resulting from the above-mentioned effective length. The diameter of the (because of the steep angle of bombardment) almost circular openings of the recesses at the surface is 1.9to 2 μm which corresponds to a surface of about 3 μm²=3·10⁻⁸ cm². The total surface area covered by recesses being the product of recess surface and total irradiation density, thus is about 1.5 cm² per surface unit of 1 cm² and, therefore, corresponds to a theoretical surface proportion of about 150%. The etching process is thus continued in this case until the surface covered by recesses mathematically exceeds the available surface by about 50. The process is called overetching and is characterized by strong overlapping of the recesses. The result of this formation is a foil with a strongly fissured surface and a pronounced depth relief. A typical example is shown in FIG. 5. The foil has an extremely high specific surface. Its mechanical stability is maintained since the thickness of the structured area amounts to only about one third of its total thickness.

The foil structured in this manner is subjected to aluminum vapor deposition at a working pressure of □1·10⁻¹ mbar. The vapor deposition time required to yield a particular layer thickness has to be determined experimentally. In contrast to conventional Al-coated foils the Al layer thus precipitated is not only adhesively bonded to the substrate but is additionally mechanically anchored in the recesses thereof.

Many practical applications of such Al-coated polymeric foils require subsequent oxidation which generate mechanical stresses in the Al₂O₃-AlₓO_{y}-Al polymer layer system. (AlₓO_{y} is a non-stoichiometric transition layer between the metal and the oxide which is characterized by a continuous change in the oxygen content.) The system consisting of the oxide, transition layer and metal is of great connection strength; but the mechanical stresses are transmitted to the metal and polymer composite. In conventionally coated foils this what result in flaking of the layer off the substrate (polymer). Based on the mechanical anchoring realized by the invention, the connecting strength of the layer is improved so much that flaking as a result of surface oxidation is prevented. Similarly, the flexibility of the product is improved so that it may be wound up as a roll with a very small internal bending ration.

Such foils with aluminum vapor deposition and having an oxidized surface may be used as starter materials for the production of electrolytic capacitors.

1. A method of processing carrier material by heavy ion irradiation and subsequent etching process for generating recesses leading from the surface of the carrier material into the interior of the carrier material, the heavy ion irradiation being carried out such that the influx of a bundle of rays (1) of high-energy heavy ions (1.1) onto a carrier surface (2) takes place under at least two different angles, characterized by the fact that by controlling the irradiation, especially by the parameters
applied irradiation density of the heavy ions;
influx angle of the heavy ion beams (1.1) onto a carrier surface (2);
angle of the different influx directions of the heavy ion beams against each other;
range of the radiation in the solids body; and
energy dissipation per unit of length along the trajectories of the high-energy heavy ions penetrating into the solids body
and the subsequent etching process as large a number of common intersections are generated each of which connects two recesses with each other to an united volume unit and the intersections of which are to be found in areas of the recesses in the interior thereof, i.e. within the area of the solids body and as far away as possible from the area of the carrier material near its surface, and that the result of the subsequent etching process is recesses of an aspect ration A, i.e. the ratio of the length relative to the average radial extent of the recesses (4), from A≧3, if possible A≈4.

2. The method of claim 1, characterized by the fact that collimation and blocking of heavy ion beams (1.1) are combined for generating as large a number of common intersections (4) in foils (2) as carrier material by repeatedly passing the foils (2) below an irradiation mask (5), the ion beams (1.1) in every passing of the foils impinging upon the foil, i.e. the carrier material, at a bombardment angle ±α or +α₁/α₂.

3. The method of claim 2, characterized by the fact that the heavy ions (1.1) do not permeate the foils, i.e. the carrier material (2).

4. The method of one of claim 3, that the heavy ion irradiation and the subsequent etching result in undercut recesses (4) which to the extent possible are of frusto-conical shapes, cavities.

5. The method of claim 4, characterized by the fact that the result of the etching process recesses (4) of a basic geometric shape of lobes and similar shapes at a constant aspect ratio A≧3 are formed to an ion trace foil which depending upon the conditions of irradiation form a surface-depth-relief with as large as possible a number of recesses with common intersections and thus, following the subsequent coating process, form a stable and lasting anchoring of the applied cover layer in the ion trace foil in the united volume units consisting of recesses with common intersections, formed tie-ins and additionally etched-out undercuts in the surface of the carrier material.

6. The method of claim 5, characterized by the fact that as a result of the selected processing steps during irradiation and etching, the surface-depth-relief of the carrier foil (2) has a fractal structure of the fractal dimension D of 2<d<3, the etching conditions having to be selected such that a large number of recesses (4) with common intersections and an aspect ratio of the recesses (4) A≧3 is maintained.

7. An system for processing carrier material by heavy ion irradiation, the source of radiation used being a heavy ion accelerator, i.e. a linear accelerator (e.g. RFQ-accelerator) or circular accelerator (e.g. cyclotron), wherein an partial portion of the ion rays (1.1) may be blocked by a diaphragm (11) arranged between the source of radiation and the carrier material (2) and the ion rays (1.1) after passing the diaphragm (11) impinging upon the surface of the carrier material (2) to be processed, characterized by the fact that a deceleration module (13) is arranged between the source of radiation and the diaphragm (11), the aimed bundle of rays penetrating into the carrier material at a defined influx energy depending upon the adjustment of the thickness of the deceleration module thus providing a defined range and energy dissipation of the penetrating heavy ions.

8. The system of claim 7, characterized by the fact that in case the carrier material is a foil strip, there is provided a symmetrically or asymmetrically constructed roller system for transport of the foil, the arrangement being constructed as follows:
a) a source of radiation;
b) a deceleration module (13), arranged as seen in the direction of heavy ion beam (1.1) propagation in front of the diaphragm (11) and in front of the roller system (8,9,10) and thus in front of the foil strip, i.e. the carrier material (2), running thereon;
c) a feed roller (6) for the still unprocessed foil strip, i.e. carrier material (2), at the beginning of the processing path;
d) a take-up roller (7) for the irradiated foil strip, i.e. the carrier material (2), at the end of the processing path;
e) a deflection roller (9) adjustably arranged on a rail (12) arranged in parallel and vertically to the bundle of rays of heavy ions (1); and
f) two fixing rollers (8,10) respectively arranged between the feed roller (6) and deflection roller (9) and deflection roller (9) and the take-up roller (7), the fixing rollers (8,10) and the feed roller (6) as well as the take-up roller (7) not lying in a common plane.

9. The system of claim 8, characterized by the fact that the deceleration module (13) consists of foils and that the deceleration module (13) over its longitudinal extent is provided with foils of different thicknesses in order for each influx angle +α₁ or −α₂ to ensure a desired influx value of the ions penetrating into the carrier material (2).
